(19) United States
(12) Patent Application Publication
(10) Pub. No.: US 2011/0113931 A1
(43) Pub. Date: May 19, 2011

(54) WRENCH

(75) Inventor: TAI-YANG LU, Chang-Hua Hsien (TW)

(73) Assignee: METALTECH INDUSTRIAL CO., LTD., Chang-Hua Hsien (TW)

(21) Appl. No.: 12/712,941

(22) Filed: Feb. 25, 2010

(30) Foreign Application Priority Data
Nov. 13, 2009 (TW) 098138618

(51) Int. Cl. B25B 13/46; B25B 13/08; B25B 13/04

(52) U.S. Cl. 81/60; 81/52; 81/125.1

(57) ABSTRACT

A wrench of the present invention includes a main body having a handle and a driving portion. The main body is made from aluminum alloy, which consists of Si, Fe, Cu, Mn, Mg, Cr, Zn, Ti and Al. Specifically, the aluminum alloy has less than 1% by weight of Si, less than 1% by weight of Fe, 1-5% by weight of Cu, less than 1% by weight of Mn, 2-5% by weight of Mg, less than 1% by weight of Cr, 5-9% by weight of Zn and less than 1% by weight of and the rest part thereof is Al.

### BACKGROUND OF THE INVENTION

1. Field of the Invention

The present invention relates to a hand tool, and more particularly to a wrench.

2. Description of the Prior Art

Conventional wrenches are mostly made from steel. The electro-plating is the most common surface treatment for such steel wrench. However, the color of the electro-plating treated wrench is limited, and the weight of such steel wrench is heavy.

The present invention is, therefore, arisen to obviate or at least mitigate the above-mentioned disadvantages.

### SUMMARY OF THE INVENTION

The main object of the present invention is to provide a wrench with light-weighted property and excellent mechanical strength.

To achieve the above and other objects, a wrench of the present invention includes a main body having a handle and a driving portion. The main body is made from aluminum alloy, which consists of Si, Fe, Cu, Mn, Mg, Cr, Zn, Ti and Al. Specifically, the aluminum alloy has less than 1% by weight of Si, less than 1% by weight of Fe, 1-5% by weight of Cu, less than 1% by weight of Mn, 2-5% by weight of Mg, less than 1% by weight of Cr, 5-9% by weight of Zn and less than 1% by weight of Ti, and the rest part thereof is Al.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a wrench of the present invention;

FIG. 2 is a partial profile showing a wrench of the present invention.

### DETAILED DESCRIPTION OF THE PREFERRED EMBODIMENTS

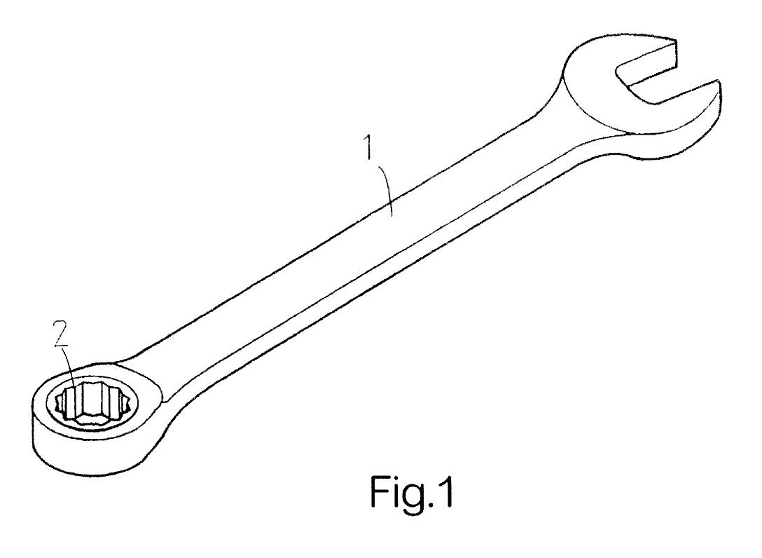

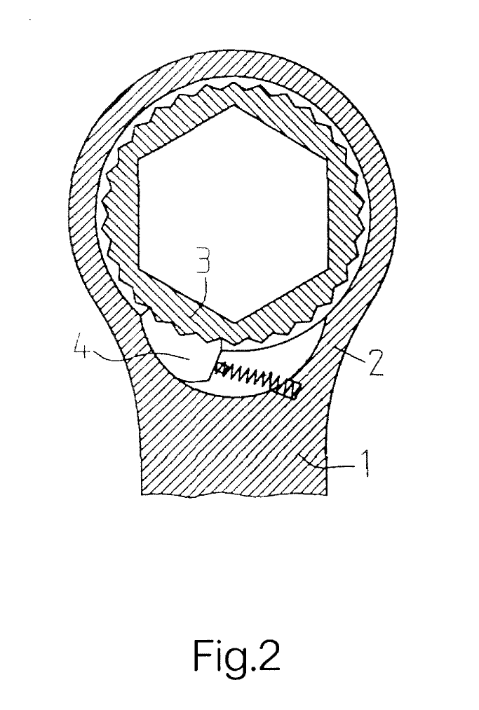

Please refer to FIG. 1 and FIG. 2. A wrench of the present invention includes a main body, which has a handle 1 and a driving portion 2 attached to the handle 1. In the present embodiment, two ends of the handle 1 are formed with a driving portion respectively. The driving portion 2 may be an open-type which consists of two jaws as shown in the present embodiment. The driving portion 2 may also be a slidable-type, i.e. the two jaws consist of a fixed jaw and a movable jaw. In addition, another driving portion 2 of the present embodiment is annular shaped. A driving ring 3 is disposed in the driving portion 2 for driving a workpiece such as a nut. An abutting element 4 is disposed between the driving ring 3 and the driving portion 2. The abutting element 4 and the driving ring 3 have a plurality of teeth respectively for the abutting element 4 to selectively engage with the driving ring 3. That is, the driving portion may be a ratchet-type. Preferably, the abutting element 4 and the driving ring 3 are both made from steel. On the other hand, the inner periphery of the driving portion 2 may he formed with a polygonal bore to directly drive a workpiece, i.e. the driving portion may be a ring-type.

In the present invention, the main body is made from aluminum alloy, which consists of Si, Fe, Cu, Mn, Mg, Cr, Zn, Ti and Al. More specifically, the aluminum alloy has less than 1% by weight of Si, less than 1% by weight of Fe, 1-5% by weight of Cu, less than 1% by weight of Mn, 2-5% by weight of Mg, less than 1% by weight of Cr, 5-9% by weight of Zn and less than 1% by weight of Ti, and the rest part thereof is Al.

Preferably, the aluminum alloy has less than 0.5% by weight of Si, less than 0.6% by weight of Fe, 1-3% by weight of Cu, less than 0.5% by weight of Mn, 2-4% by weight of Mg, less than 0.5% by weight of Cr, 6-8% by weight of Zn and less than 0.5% by weight of Ti. And, of course, the rest part of the aluminum alloy is still Al.

The following table is a comparison of the aluminum alloy of the present invention and conventional aluminum alloys:

TABLE 1

| Aluminum alloy # | Tensile strength (Mpa) |
|---|---|
| 6061 | 310 |
| 7005 | 350 |
| The present invention | 700 |

As shown in Table 1, the tensile strength of the aluminum alloy of the present invention can reach 700 Mpa, which is twice that of the conventional 6061 and 7005 aluminum alloys.

Accordingly, the wrench of the present invention fits in with the international standard on strength. Yet the weight thereof is only about 40% that of the conventional steel wrench. Furthermore, aluminum alloy is a material that can be recycled more easily than steel, thus the wrench of the present invention is more environmental friendly.

In addition, at least part of the surface of the main body can undergo a surface treatment in an anodizing manner, so the wrench can have more choices of color.

What is claimed is:

1. A wrench, comprising a main body, the main body having a handle and a driving portion, the main body being made from aluminum alloy, which consists of Si, Fe, Cu, Mn, Mg, Cr, Zn, Ti and Al;
wherein the aluminum alloy has less than 1% by weight of Si, less than 1% by weight of Fe, 1-5% by weight of Cu, less than 1% by weight of Mn, 2-5% by weight of Mg, less than 1% by weight of Cr, 5-9% by weight of Zn and less than 1% by weight of Ti, and the rest part of the aluminum alloy is Al.

2. The wrench of claim 1, wherein the aluminum alloy has less than 0.5% by weight of Si, less than 0.6% by weight of Fe, 1-3% by weight of Cu, less than 0.5% by weight of Mn, 2-4% by weight of Mg, less than 0.5% by weight of Cr, 6-8% by weight of Zn and less than 0.5% by weight of Ti.

3. The wrench of claim 1, wherein the main body has at least a part of its surface being anodizing treated.

4. The wrench of claim 2, wherein the main body has at least a part of its surface being anodizing treated.

5. The wrench of claim 1, wherein the driving portion comprises two jaws.

6. The wrench of claim 5, wherein the two jaws consist of a fixed jaw and a movable jaw.

7. The wrench of claim 1, wherein the driving portion is annular shaped;
a driving ring for driving a workpiece, disposed in the driving portion;
an abutting element, disposed between the driving ring and the driving portion, the driving ring and the abutting element have a plurality of teeth respectively for the abutting element to selectively engage with the driving ring.

8. The wrench of claim 7, wherein the abutting element and the driving ring are both made from steel.
